(19) United States
(12) Patent Application Publication
(10) Pub. No.: US 2025/0109357 A1
(43) Pub. Date: Apr. 3, 2025

(54) AUTOMATIC DISHWASHING COMPOSITION

(71) Applicant: Dow Silicones Corporation, Midland, MI (US)

(72) Inventors: Saugata Nad, Brussels (BE); Serge Creutz, Liege (BE); Emma Bousset, Charleroi (BE); Severine Cauvin, Mons (BE)

(21) Appl. No.: 18/713,223

(22) PCT Filed: Nov. 30, 2022
(86) PCT No.: PCT/US2022/051306

§ 371 Date: May 24, 2024

Related U.S. Application Data
(60) Provisional application No. 63/285,621, filed on Dec. 3, 2021.

(51) Int. Cl. C11D 3/20; C11D 1/72; C11D 3/10; C11D 3/12; C11D 3/33; C11D 3/34; C11D 3/36; C11D 3/37; C11D 3/386; C11D 3/39; C11D 3/395

(52) U.S. Cl. CPC C11D 3/2089; C11D 1/72; C11D 3/10; C11D 3/1246; C11D 3/2003; C11D 3/2086; C11D 3/33; C11D 3/3418; C11D 3/361; C11D 3/3707; C11D 3/386; C11D 3/3917; C11D 3/3958; C11D 2111/10

(57) ABSTRACT

An automatic dishwashing composition is provided including 20 to <98.6 wt %, based on weight of the automatic dishwashing composition, of a builder; 0.2 to 20 wt %, based on weight of the automatic dishwashing composition, of a nonionic surfactant; 0.1 to <10 wt %, based on weight of the automatic dishwashing composition, of a substance of formula I

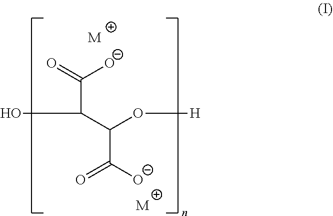

wherein n is ≥2 and wherein each M^{⊕} is a counter ion; >0.005 to 6 wt %, based on weight of the automatic dishwashing composition, of a protease; and wherein the weight of the substance of formula I divided by the weight of the protease in the automatic dishwashing composition is <20.

The present invention relates to a dispersant polymer for use in automatic dish washing formulations. In particular, the present invention relates to automatic dishwashing compositions, comprising: 20 to <98.6 wt %, based on weight of the automatic dishwashing composition, of a builder; 0.2 to 20 wt %, based on weight of the automatic dishwashing composition, of a nonionic surfactant; 0.1 to <10 wt %, based on weight of the automatic dishwashing composition, of a substance of formula I

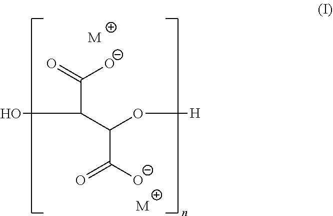

wherein n is ≥2 and wherein each M^{⊕} is a counter ion; >0.005 to 6 wt %, based on weight of the automatic dishwashing composition, of a protease; and wherein the weight of the substance of formula I divided by the weight of the protease in the automatic dishwashing composition is <20.

Automatic dishwashing compositions are generally recognized as a class of detergent compositions distinct from those used for fabric washing or water treatment. Automatic dishwashing compositions are expected by users to produce a spotless and film-free appearance on washed articles after a complete cleaning cycle.

Phosphate-free automatic dishwashing compositions are increasingly desirable. Phosphate-free automatic dishwashing compositions typically rely on non-phosphate builders, such as salts of citrate, carbonate, silicate, disilicate, bicarbonate, aminocarboxylates and others to sequester calcium and magnesium from hard water, and upon drying, leave an insoluble visible deposit.

A family of polycarboxylate copolymers and their use as builders in detergent compositions and rinse aid compositions is disclosed by Christopher et al. in U.S. Pat. No. 5,431,846 for use in the final rinse step of a dish or warewashing machine. Christopher et al. disclose block copolymers comprising from 20 to 95 mole % of monomer units derived from itaconic acid or a homologue thereof and from 5 to 80 mole % of monomer units derived from vinyl alcohol or a lower vinyl ester are excellent binders of divalent or polyvalent metals and are useful as potentially biodegradable builders in detergent compositions as well as in machine dishwashing compositions and anti-scaling rinse compositions.

A family of terpolymers and their use, among other things, as dispersants is disclosed by Swift et al in U.S. Pat. No. 5,191,048. Swift et al teach a terpolymer comprising as polymerized units from about 15 to 55 mole percent of at least one first monomer selected from the group consisting of vinyl acetate, vinyl ethers and vinyl carbonates, from about 10 to 70 mole percent of at least one second monomer of an ethylenically unsaturated monocarboxylic acid, and from about 15 to 55 mole percent of at least one third monomer of an anhydride of a dicarboxylic acid and wherein said terpolymer is formed in a non-aqueous system such that less than about one more percent of the monomers are hydrolyzed during said polymerization.

Notwithstanding there remains a need for new automatic dish washing formulations. In particular, there remains a need for new automatic dish washing formulations that provide effective spotting/filming shine performance with an improved balance of biosourced and biodegradable ingredients.

The present invention provides an automatic dishwashing composition, comprising: 20 to <98.6 wt %, based on weight of the automatic dishwashing composition, of a builder, 0.2 to 20 wt %, based on weight of the automatic dishwashing composition, of a nonionic surfactant; 0.1 to <10 wt %, based on weight of the automatic dishwashing composition, of a substance of formula I

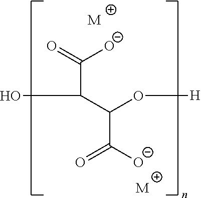

wherein n is ≥2 and wherein each M^{⊕} is a counter ion; and >0.005 to 6 wt %, based on weight of the automatic dishwashing composition, of a protease; wherein the weight of the substance of formula I divided by the weight of the protease in the automatic dishwashing composition is <20.

The present invention provides an automatic dishwashing composition, comprising: 20 to <98.6 wt %, based on weight of the automatic dishwashing composition, of a builder, 0.2 to 20 wt %, based on weight of the automatic dishwashing composition, of a nonionic surfactant; 0.1 to <10 wt %, based on weight of the automatic dishwashing composition, of a substance of formula I, wherein n is ≥2 and wherein each M^{⊕} is a counter ion; and >0.3 to 6, based on weight of the automatic dishwashing composition, of a protease; wherein the weight of the substance of formula I divided by the weight of the protease in the automatic dishwashing composition is <20.

The present invention provides an automatic dishwashing composition, comprising: 20 to <98.6 wt %, based on weight of the automatic dishwashing composition, of a builder, 0.2 to 20 wt %, based on weight of the automatic dishwashing composition, of a nonionic surfactant; 0.1 to <10 wt %, based on weight of the automatic dishwashing composition, of a substance of formula I, wherein n is ≥2 and wherein each M^{⊕} is a counter ion; and >0.3 to 6, based on weight of the automatic dishwashing composition, of a protease; wherein the automatic dishwashing composition is an anhydrous formulation containing <2 wt %, based on weight of the automatic dishwashing composition, of water; and wherein the weight of the substance of formula I divided by the weight of the protease in the automatic dishwashing composition is <20.

The present invention provides an automatic dishwashing composition, comprising: 20 to <98.6 wt %, based on weight of the automatic dishwashing composition, of a builder, 0.2 to 20 wt %, based on weight of the automatic dishwashing composition, of a nonionic surfactant; 0.1 to <10 wt %, based on weight of the automatic dishwashing composition, of a substance of formula I, wherein n is ≥2 and wherein each M^{⊕} is a counter ion; and >0.3 to 6, based on weight of the automatic dishwashing composition, of a protease; wherein the automatic dishwashing composition is an anhydrous formulation containing <2 wt %, based on weight of the automatic dishwashing composition, of water; wherein the automatic dishwashing composition contains <2 wt %, based on weight of the automatic dishwashing composition, of alkyl benzene sulfonates; and wherein the weight of the substance of formula I divided by the weight of the protease in the automatic dishwashing composition is <20.

The present invention provides an automatic dishwashing composition, comprising: 20 to <98.6 wt %, based on weight of the automatic dishwashing composition, of a builder, 0.2 to 20 wt %, based on weight of the automatic dishwashing composition, of a nonionic surfactant; 0.1 to <10 wt %, based on weight of the automatic dishwashing composition, of a substance of formula I, wherein n is ≥2 and wherein each M^{⊕} is a counter ion; and >0.3 to 6, based on weight of the automatic dishwashing composition, of a protease; wherein the automatic dishwashing composition is an anhydrous formulation containing <2 wt %, based on weight of the automatic dishwashing composition, of water; wherein the automatic dishwashing composition contains <2 wt %, based on weight of the automatic dishwashing composition, of alkyl benzene sulfonates; and wherein the automatic dishwashing composition contains less than 0.1 wt %, based on weight of the automatic dishwashing composition, of an iron and manganese chelating agent selected from the group consisting of:
a) amino carboxylates having one or more units of the substructure:

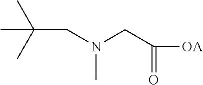

b) amino phosphonates having one or more units of the substructure:

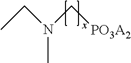

c) polyfunctionally-substituted aromatic chelating agents consisting of compounds having the formula:

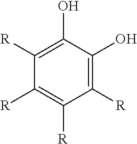

wherein A is hydrogen, an alkali metal, ammonium or substituted ammonium; wherein x is 1 to 3; and wherein at least one R is —SO₃H, or —COOH or soluble salts thereof and mixtures thereof; and d) mixtures thereof.

The present invention provides a method of cleaning an article in an automatic dishwashing machine, comprising: providing at least one soiled article; providing an automatic dishwashing composition according to the present invention; and, applying the automatic dishwashing composition to the at least one soiled article to provide a cleaned article.

### DETAILED DESCRIPTION

When incorporated in an automatic dishwashing composition (particularly phosphate-free and phosphonate-free automatic dishwashing compositions), the combination of a substance of formula I with a protease and a non-ionic surfactant, surprisingly provides antispotting/antifilming shine performance that is at least on par with conventional automatic dishwashing formulations, while significantly improving the overall sustainability of the automatic dishwashing composition.

Unless otherwise indicated, ratios, percentages, parts, and the like are by weight. Weight percentages (or wt %) in the composition are percentages of weight, i.e., excluding any water that may be present in the composition. Percentages of monomer units in the polymer are percentages of weight, i.e., excluding any water present in a polymer emulsion.

As used herein, unless otherwise indicated, the terms “weight average molecular weight” and “Mw” are used interchangeably to refer to the weight average molecular weight as measured in a conventional manner with gel permeation chromatography (GPC) and conventional standards, such as polystyrene standards. GPC techniques are discussed in detail in Modem Size Exclusion Chromatography, W. W. Yau, J. J. Kirkland, D. D. Bly; Wiley-Interscience, 1979, and in A Guide to Materials Characterization and Chemical Analysis, J. P. Sibilia; VCH, 1988, p. 81-84. Weight average molecular weights are reported herein in units of Daltons.

Preferably, the automatic dishwashing composition of the present invention, comprises: 20 to <98.6 wt % (preferably, 30 to 90 wt %; more preferably, 40 to 85 wt %; most preferably, 50 to 75 wt %), based on weight of the automatic dishwashing composition, of a builder (preferably, wherein the builder includes at least one of a carbonate, a bicarbonate, a citrate and a silicate); 0.2 to 20 wt % (preferably, 1 to 15 wt %; more preferably, 2 to 12 wt %; most preferably, 3 to 10 wt %), based on weight of the automatic dishwashing composition, of a nonionic surfactant (preferably, wherein the nonionic surfactant is a fatty alcohol alkoxylate); 0.1 to <10 wt % (preferably, 0.5 to 9 wt %; more preferably, 0.7 to 8 wt %; most preferably, 0.75 to 7.5 wt %), based on weight of the automatic dishwashing composition, of a substance of formula I

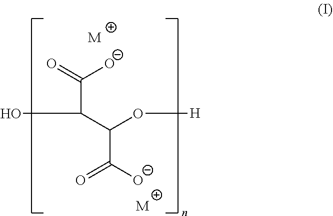

wherein n is ≥2 (preferably, 2 to 40; more preferably, 2 to 25; most preferably, 2 to 10); wherein each M^{⊕} is a counter ion (preferably, wherein each M^{⊕} is independently selected from the group consisting of H⁺, alkali metal cations, ammonium and substituted ammonium (e.g., tetraethylammonium); more preferably, wherein each M^{⊕} is independently selected from the group consisting of H⁺, Na⁺, Li⁺, K⁺ and NH₄⁺; more preferably, wherein each M^{⊕} is independently selected from the group consisting of H⁺, Na⁺ and K⁺; most preferably, wherein each M^{⊕} is independently selected from the group consisting of H⁺ and Na⁺) (preferably, wherein the substance of formula I has a weight average molecular weight of at least 400 Daltons (preferably, 400 to 20,000 Daltons; more preferably, 400 to 1,500 Daltons)); >0.005 to 6 (preferably, >0.3 to 5 wt %; more preferably, 0.4 to 4 wt %; most preferably, 0.75 to 3.25 wt %), based on weight of the automatic dishwashing composition, of a protease; 0 to 25 wt % (preferably, 5 to 22 wt %; more preferably, 7.5 to 20; most preferably, 10 to 20 wt %), based on weight of the automatic dishwashing composition, of a bleaching agent (preferably, wherein the bleaching agent includes sodium percarbonate); 0 to 10 wt % (preferably, 0.5 to 8 wt %; more preferably, 1 to 7.5 wt %; most preferably, 2 to 6 wt %), based on weight of the automatic dishwashing composition, of a bleach activator (preferably, wherein the bleach activator includes tetraacetylethylenediamine (TAED)); 0 to 6 wt % (preferably, 0.4 to 5 wt %; more preferably, 0.5 to 3 wt %; most preferably, 0.75 to 2 wt %), based on weight of the automatic dishwashing composition, of a non-protease enzyme (preferably, wherein the non-protease enzyme includes an amylase); 0 to 10 wt % (preferably, 0.5 to 8 wt %; more preferably, 1 to 7.5 wt %; most preferably, 2 to 6 wt %), based on weight of the automatic dishwashing composition, of a binder agent (preferably, wherein the binder is a polyethylene glycol); and 0 to 75 wt %, based on weight of the automatic dishwashing composition, of a filler, wherein the weight of the substance of formula I divided by the weight of the protease in the automatic dishwashing composition is <20 (preferably, 0.1 to <20; more preferably, 0.25 to 15; most preferably, 0.4 to 10).

Preferably, the automatic dishwashing composition of the present invention, comprises 20 to <98.6 wt % (preferably, 30 to 90 wt %; more preferably, 40 to 85 wt %; most preferably, 50 to 75 wt %), based on weight of the automatic dishwashing composition, of a builder; wherein the builder comprises at least one of a carbonate, a citrate and a silicate. More preferably, the automatic dishwashing composition of the present invention, comprises 20 to <98.6 wt % (preferably, 30 to 90 wt %; more preferably, 40 to 85 wt %; most preferably, 50 to 75 wt %), based on weight of the automatic dishwashing composition, of a builder; wherein the builder comprises a mixture of a carbonate and a citrate. Most preferably, the automatic dishwashing composition of the present invention, comprises 20 to <98.6 wt % (preferably, 30 to 90 wt %; more preferably, 40 to 85 wt %; most preferably, 50 to 75 wt %), based on weight of the automatic dishwashing composition, of a builder; wherein the builder comprises a mixture of a sodium carbonate, sodium bicarbonate and sodium citrate. Weight percentages of carbonates, citrates and silicates are based on the actual weights of the salts, including metal ions.

The term “carbonate(s)” as used herein and in the appended claims refers to alkali metal or ammonium salts of carbonate, bicarbonate, percarbonate, and/or sesquicarbonate. Preferably, the carbonate used in the automatic dishwashing composition (if any) is selected from the group consisting of carbonate salts of sodium, potassium and lithium (more preferably, salts of sodium or potassium; most preferably, salts of sodium). Percarbonate used in the automatic dishwashing composition (if any) is selected from salts of sodium, potassium, lithium and ammonium (more preferably, salts of sodium or potassium; most preferably, salts of sodium). Most preferably, the carbonate used in the automatic dishwashing composition (if any) includes at least one of sodium carbonate and sodium bicarbonate. Preferably, when the builder used in the automatic dishwashing composition of the present invention includes carbonate, the automatic dishwashing composition preferably, comprises 0 to 98.6 wt % (preferably, 5 to 75 wt %; more preferably, 10 to 60 wt %; most preferably 20 to 50 wt %), based on weight of the automatic dishwashing composition, of a carbonate.

The term “citrate(s)” as used herein and in the appended claims refers to alkali metal citrates. Preferably, the citrate used in the automatic dishwashing composition (if any) is selected from the group consisting of citrate salts of sodium, potassium and lithium (more preferably, salts of sodium or potassium; most preferably, salts of sodium). More preferably, the citrate used in the automatic dishwashing composition (if any) is sodium citrate. Preferably, when the builder used in the automatic dishwashing composition of the present invention includes citrate, the automatic dishwashing composition preferably, comprises 0 to 98.6 wt % (preferably, 5 to 75 wt %; more preferably, 10 to 60 wt %; most preferably 20 to 40 wt %), based on weight of the automatic dishwashing composition, of the citrate.

The term “silicate(s)” as used herein and in the appended claims refers to alkali metal silicates. Preferably, the silicate used in the automatic dishwashing composition (if any) is selected from the group consisting of silicate salts of sodium, potassium and lithium (more preferably, salts of sodium or potassium; most preferably, salts of sodium). More preferably, the silicate used in the automatic dishwashing composition (if any) is sodium disilicate. Preferably, the builder used in the automatic dishwashing composition of the present invention includes a silicate. Preferably, when the builder used in the automatic dishwashing composition of the present invention includes a silicate, the automatic dishwashing composition preferably, comprises 0 to 98.6 wt % (preferably, 0.1 to 10 wt %; more preferably, 0.5 to 7.5 wt %; most preferably 0.75 to 3 wt %), based on weight of the automatic dishwashing composition, of the silicate(s).

Preferably, the automatic dishwashing composition of the present invention, comprises: 0.2 to 20 wt % (preferably, 1 to 15 wt %; more preferably, 2 to 12 wt %; most preferably, 3 to 10 wt %), based on weight of the automatic dishwashing composition, of a nonionic surfactant. More preferably, the automatic dishwashing composition of the present invention, comprises: 0.2 to 20 wt % (preferably, 1 to 15 wt %; more preferably, 2 to 12 wt %; most preferably, 3 to 10 wt %), based on weight of the automatic dishwashing composition, of a nonionic surfactant; wherein the non-ionic surfactant is selected from the group consisting of polyoxyalkylene surfactants, polyalkylene glycol esters, polyoxyethylene derivatives of fatty acid esters of polyhydric alcohols, fatty acid esters of polyalkoxylated polyhydric alcohols, polyalkoxylated natural fats and oils, polyalkylene oxide block copolymers, alkyl polyglucosides, sucrose esters and mixtures thereof. Still more preferably, the automatic dishwashing composition of the present invention, comprises: 0.2 to 20 wt % (preferably, 1 to 15 wt %; more preferably, 2 to 12 wt %; most preferably, 3 to 10 wt %), based on weight of the automatic dishwashing composition, of a nonionic surfactant; wherein the non-ionic surfactant includes a fatty alcohol alkoxylate. Most preferably, the automatic dishwashing composition of the present invention, comprises: 0.2 to 20 wt % (preferably, 1 to 15 wt %; more preferably, 2 to 12 wt %; most preferably, 3 to 10 wt %), based on weight of the automatic dishwashing composition, of a nonionic surfactant; wherein the non-ionic surfactant is a fatty alcohol alkoxylate according to formula II

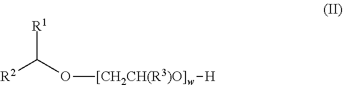

wherein w is an average of 5 to 100 (preferably, 6 to 75; more preferably, 7 to 60; most preferably, 8 to 50); wherein R¹ is selected from the group consisting of a hydrogen and a linear or branched C₁₋₂₀ alkyl group (preferably, a hydrogen, and a linear or branched C₁₋₂₀ alkyl group; more preferably, a hydrogen and a linear C₁₋₂₀ alkyl group); wherein R² is selected from the group consisting of a linear or branched C₁₋₂₀ alkyl group and a linear or branched C₁₋₄ hydroxyalkyl group (preferably, a linear or branched C₁₋₂₀ alkyl group; more preferably, a linear C₁₋₂₀ alkyl group); wherein each R³ is independently selected from the group consisting of a hydrogen, a methyl group, an ethyl group, a n-propyl group, an iso-propyl group, a n-butyl group, a 2-butyl group and a 2-methyl-2-butyl group (preferably, a hydrogen, a methyl group and an ethyl group); and with the proviso that sum of the total number of carbon atoms in R¹ and R² is 5 to 21 (preferably, 6 to 20 carbon atoms; more preferably, 7 to 20 carbon atoms).

Preferably, the automatic dishwashing composition of the present invention, comprises: 0.1 to <10 wt % (preferably, 0.5 to 9 wt %; most preferably, 0.7 to 8 wt %; most preferably, 0.75 to 7.5 wt %), based on weight of the automatic dishwashing composition, of a substance of formula I

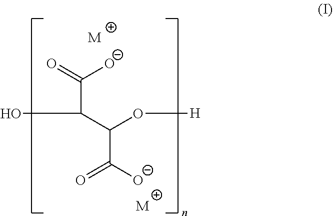

wherein n is ≥2 (preferably, 2 to 40; more preferably, 2 to 25; most preferably, 2 to 10); wherein each M^{⊕} is a counter ion (preferably, wherein each M^{⊕} is independently selected from the group consisting of H⁺, alkali metal cations, ammonium and substituted ammonium (e.g., tetraethylammonium); more preferably, wherein each M^{⊕} is independently selected from the group consisting of H⁺, Na⁺, Li⁺, K⁺ and NH₄⁺; more preferably, wherein each M is independently selected from the group consisting of H⁺, Na⁺ and K⁺; most preferably, wherein each M^{⊕} is independently selected from the group consisting of H⁺ and Na⁺); and wherein the substance of formula I has a weight average molecular weight of at least 400 Daltons (preferably, 400 to 20,000 Daltons; more preferably, 400 to 1,500 Daltons). More preferably, the automatic dishwashing composition of the present invention, comprises: 0.1 to <10 wt % (preferably, 0.5 to 9 wt %; most preferably, 0.7 to 8 wt %; most preferably, 0.75 to 7.5 wt %), based on weight of the automatic dishwashing composition, of a substance of formula I; wherein n is 2 to 40 (preferably, 2 to 25; most preferably, 2 to 10); wherein each M^{⊕} is independently selected from the group consisting of Na⁺ and H⁺; and wherein the substance of formula I has a weight average molecular weight of at least 400 Daltons (preferably, 400 to 20,000 Daltons; more preferably, 400 to 1,500 Daltons).

Preferably, the automatic dishwashing composition of the present invention, comprises: >0.005 to 6 (preferably, >0.3 to 5 wt %; more preferably, 0.4 to 4 wt %; most preferably, 0.75 to 3.25 wt %), based on weight of the automatic dishwashing composition, of a protease; wherein the protease is a serine protease (EC No. 3.4.21). More preferably, the automatic dishwashing composition of the present invention, comprises: >0.005 to 6 (preferably, >0.3 to 5 wt %; more preferably, 0.4 to 4 wt %; most preferably, 0.75 to 3.25 wt %), based on weight of the automatic dishwashing composition, of a protease; wherein the protease is a serine protease selected from the group consisting of serine endopeptidases. Most preferably, the automatic dishwashing composition of the present invention, comprises: >0.005 to 6 (preferably, >0.3 to 5 wt %; more preferably, 0.4 to 4 wt %; most preferably, 0.75 to 3.25 wt %), based on weight of the automatic dishwashing composition, of a protease; wherein the protease is a serine endopeptidase mainly of subtilisin A (EC No. 3.4.21.62).

The automatic dishwashing composition of the present invention, optionally further comprises: an additive. Preferably, the automatic dishwashing composition of the present invention, further comprises: an additive selected from the group consisting of a phosphonate (e.g., hydroxy ethylidene diphosphonic acid (HEDP); an alkaline source; a bleaching agent (e.g., sodium percarbonate, sodium perborate); a bleach activator (e.g., tetraacetylethylenediamine (TAED)); a bleach catalyst (e.g., manganese(II) acetate, cobalt(II) chloride, bis(TACN)magnesium trioxide diacetate); a non-protease enzyme (e.g., amylase, lipase, or cellulase); a foam suppressant; a coloring agent; a fragrance; a silicate; an additional builder; an antibacterial agent; a filler; a deposit control polymer (e.g., polyalkylene oxide polymer); and mixtures thereof. More preferably, the automatic dishwashing composition of the present invention, further comprises an additive, wherein the additive is selected from the group consisting of a bleaching agent, a bleach activator, a non-protease enzyme, a filler; a deposit control polymer; and mixtures thereof. Still more preferably, the automatic dishwashing composition of the present invention, further comprises an additive, wherein the additive includes a bleaching agent, wherein the bleaching agent includes sodium percarbonate; a bleach activator, wherein the bleach activator includes tetraacetylethylenediamine (TAED)); a non-protease enzyme, wherein the non-protease enzyme is selected from the group consisting of amylase, lipase, cellulase and mixtures thereof; a deposit control polymer, wherein the deposit control polymer is a polyalkylene oxide polymer; and mixtures thereof. Most preferably, the automatic dishwashing composition of the present invention, further comprises an additive, wherein the additive includes a bleaching agent, wherein the bleaching agent includes sodium percarbonate; a bleach activator, wherein the bleach activator includes tetraacetylethylenediamine (TAED); a non-protease enzyme, wherein the enzyme includes an amylase; a deposit control polymer, wherein the deposit control polymer is a polyethylene glycol polymer; and mixtures thereof.

Fillers included in automatic dishwashing composition are preferably, inert, water-soluble substances, typically sodium or potassium salts (e.g., sodium sulfate, potassium sulfate, sodium chloride, potassium chloride). In tablets and powders, fillers are typically present in amounts ranging from 0 wt % to 75 wt %. Fillers included in gel formulations typically include those mentioned for use in tablets and powders.

The automatic dishwashing composition of the present invention, optionally further comprises: an alkaline source. Suitable alkaline sources include, without limitation, alkali metal carbonates and alkali metal hydroxides, such as sodium or potassium carbonate, bicarbonate, sesquicarbonate, sodium, lithium, or potassium hydroxide, or mixtures of the foregoing. Sodium hydroxide is preferred. The amount of alkaline source in the automatic dishwashing composition of the present invention (if any) is at least 1 wt % (preferably, at least 20 wt %) and up to 80 wt % (preferably, up to 60 wt %), based on weight of the automatic dishwashing composition.

Preferably, the automatic dishwashing composition of the present invention, further comprises: 0 to 25 wt % (preferably, 5 to 22 wt %; more preferably, 7.5 to 20; most preferably, 10 to 20 wt %), based on weight of the automatic dishwashing composition, of a bleaching agent. More preferably, the automatic dishwashing composition of the present invention, further comprises: 0 to 25 wt % (preferably, 5 to 22 wt %; more preferably, 7.5 to 20; most preferably, 10 to 20 wt %), based on weight of the automatic dishwashing composition, of a bleaching agent; wherein the bleaching agent includes sodium percarbonate. Most preferably, the automatic dishwashing composition of the present invention, further comprises: 0 to 25 wt % (preferably, 5 to 22 wt %; more preferably, 7.5 to 20; most preferably, 10 to 20 wt %), based on weight of the automatic dishwashing composition, of a bleaching agent; wherein the bleaching agent is sodium percarbonate.

Preferably, the automatic dishwashing composition of the present invention, further comprises: 0 to 10 wt % (preferably, 0.5 to 8 wt %; more preferably, 1 to 7.5 wt %; most preferably, 2 to 6 wt %), based on weight of the automatic dishwashing composition, of a bleach activator. More preferably, the automatic dishwashing composition of the present invention, further comprises 0 to 10 wt % (preferably, 0.5 to 8 wt %; more preferably, 1 to 7.5 wt %; most preferably, 2 to 6 wt %), based on weight of the automatic dishwashing composition, of a bleach activator; wherein the bleach activator includes tetraacetylethylenediamine (TAED). Most preferably, the automatic dishwashing composition of the present invention, further comprises 0 to 10 wt % (preferably, 0.5 to 8 wt %; more preferably, 1 to 7.5 wt %; most preferably, 2 to 6 wt %), based on weight of the automatic dishwashing composition, of a bleach activator; wherein the bleach activator is tetraacetylethylenediamine (TAED).

Preferably, the automatic dishwashing composition of the present invention, further comprises 0 to 6 wt % (preferably, 0.4 to 5 wt %; more preferably, 0.5 to 3 wt %; most preferably, 0.75 to 2 wt %), based on weight of the automatic dishwashing composition, of a non-protease enzyme. More preferably, the automatic dishwashing composition of the present invention, further comprises 0 to 6 wt % (preferably, 0.4 to 5 wt %; more preferably, 0.5 to 3 wt %; most preferably, 0.75 to 2 wt %), based on weight of the automatic dishwashing composition, of a non-protease enzyme; wherein the non-protease enzyme is selected from the group consisting of amylase, lipase, cellulase and mixtures thereof. Most preferably, the automatic dishwashing composition of the present invention, further comprises 0 to 6 wt % (preferably, 0.4 to 5 wt %; more preferably, 0.5 to 3 wt %; most preferably, 0.75 to 2 wt %), based on weight of the automatic dishwashing composition, of a non-protease enzyme; wherein the non-protease enzyme includes an amylase.

Preferably, the automatic dishwashing composition of the present invention, further comprises 0 to 10 wt % (preferably, 0.5 to 8 wt %; more preferably, 1 to 7.5 wt %; most preferably, 2 to 6 wt %), based on weight of the automatic dishwashing composition, of a binder. More preferably, the automatic dishwashing composition of the present invention, further comprises 0 to 10 wt % (preferably, 0.5 to 8 wt %; more preferably, 1 to 7.5 wt %; most preferably, 2 to 6 wt %), based on weight of the automatic dishwashing composition, of a binder; wherein the binder is selected from the group consisting of ethoxylated tallow alcohols, polyalkylene oxides, film forming polymers, fatty acids and mixtures thereof. Still more preferably, the automatic dishwashing composition of the present invention, further comprises 0 to 10 wt % (preferably, 0.5 to 8 wt %; more preferably, 1 to 7.5 wt %; most preferably, 2 to 6 wt %), based on weight of the automatic dishwashing composition, of a binder; wherein the binder includes a polyalkylene oxide. Most preferably, the automatic dishwashing composition of the present invention, further comprises 0 to 10 wt % (preferably, 0.5 to 8 wt %; more preferably, 1 to 7.5 wt %; most preferably, 2 to 6 wt %), based on weight of the automatic dishwashing composition, of a binder; wherein the binder is a polyethylene glycol (preferably, a polyethylene glycol having a weight average molecular weight of 1,400 to 30,000 Daltons; more preferably, a polyethylene glycol having a weight average molecular weight of 1,500 to 20,000 Daltons).

Fragrances, colorants, foam suppressants, antibacterial agents usually total no more than 10 wt %, alternatively no more than 5 wt %, of the automatic dishwashing composition.

Preferably, the automatic dishwashing composition of the present invention is an anhydrous formulation. More preferably, the automatic dishwashing composition of the present invention is an anhydrous formulation containing <2 wt % (preferably, <1 wt %; more preferably, <0.75 wt %; most preferably, <0.5 wt %), based on weight of the automatic dishwashing composition, of water.

Preferably, the automatic dishwashing composition of the present invention comprises ≤1 wt % (preferably, ≤0.5 wt %; more preferably, ≤0.2 wt %; still more preferably, <0.1 wt %; yet still more preferably, ≤0.01 wt %; most preferably, <the detectable limit), based on weight of the automatic dishwashing composition, of phosphate (measured as elemental phosphorus). Preferably, the automatic dishwashing composition of the present invention is phosphate free.

Preferably, the automatic dishwashing composition of the present invention comprises ≤1 wt % (preferably, ≤0.5 wt %; more preferably, ≤0.2 wt %; still more preferably, ≤0.1 wt %; yet still more preferably, ≤0.01 wt %; most preferably, <the detectable limit), based on weight of the automatic dishwashing composition, of phosphonate (measured as elemental phosphorus). Preferably, the automatic dishwashing composition of the present invention is phosphonate free (e.g., 1-hydroxyethylidene-1,1-diphosphonic acid (HEDP) and salts thereof).

Preferably, the automatic dishwashing composition of the present invention contains <2 wt % (preferably, ≤1.5 wt %; more preferably, ≤1 wt %; still more preferably, ≤0.1 wt %; yet more preferably, ≤0.01 wt %; still yet more preferably, ≤0.001 wt %; most preferably, <detectable limit) of alkyl benzene sulfonates.

Preferably, the automatic dishwashing composition of the present invention comprises <0.1 wt % (preferably, <0.01 wt %; more preferably, <0.001 wt %; still more preferably, <0.0001 wt %; most preferably, <detectable limit), based on weight of the automatic dishwashing composition, of an iron and manganese chelating agent selected from the group consisting of: a) amino carboxylates having one or more units of the substructure:

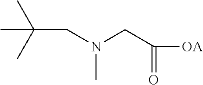

b) amino phosphonates having one or more units of the substructure:

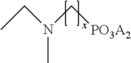

c) polyfunctionally-substituted aromatic chelating agents consisting of compounds having the formula:

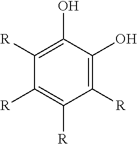

wherein A is hydrogen, an alkali metal, ammonium or substituted ammonium; wherein x is 1 to 3; and wherein at least one R is —SO₃H, or —COOH or soluble salts thereof and mixtures thereof; and d) mixtures thereof.

Preferably, the automatic dishwashing composition of the present invention has a pH (at 1 wt % in water) of at least 9 (preferably, ≥9.5). Preferably, the automatic dishwashing composition of the present invention has a pH (at 1 wt % in water) of no greater than 12.

Preferably, the automatic dishwashing composition of the present invention can be formulated in any typical form, e.g., as a tablet, powder, block, monodose, sachet, paste, liquid or gel. The automatic dishwashing compositions of the present invention are useful for cleaning ware, such as eating and cooking utensils, dishes, in an automatic dishwashing machine.

Preferably, the automatic dishwashing composition of the present invention are suitable for use under typical operating conditions. For example, when used in an automatic dishwashing machine, typical water temperatures during the washing process preferably are from 20° C. to 85° C., preferably 30° C. to 70° C. Typical concentrations for the automatic dishwashing composition as a percentage of total liquid in the dishwasher preferably are from 0.1 to 1 wt %, preferably from 0.2 to 0.7 wt %. With selection of an appropriate product form and addition time, the automatic dishwashing compositions of the present invention may be present in the prewash, main wash, penultimate rinse, final rinse, or any combination of these cycles.

Preferably, the method of cleaning an article in an automatic dishwashing machine of the present invention, comprises: providing at least one soiled article (e.g., cookware, bakeware, tableware, dishware, flatware and/or glassware); providing an automatic dishwashing composition of the present invention; and applying the automatic dishwashing composition to the at least one soiled article (preferably, in an automatic dishwasher) to provide a clean article.

Some embodiments of the present invention will now be described in detail in the following Examples.

### Comparative Examples C1-C16 and Examples 1-9: Automatic Dishwashing, Comps

Dishwashing compositions were prepared in each of Comparative Examples C1-C16 and Examples 1-9 having the component formulations identified in TABLES 1-3. The amylase used in the compositions was Excellenz S1000 amylase available from IFF. The protease used in the compositions was Excellenz P1000 protease available from IFF.

TABLE 1

| | Example (Concentration in wt %) | | | | | |
|---|---|---|---|---|---|---|
| Ingredient | C1 | C2 | C3 | C4 | 1 | 2 |
| Sodium carbonate | 33.0 | 32.0 | 31.0 | 30.5 | 30.1 | 30.5 |
| Sodium citrate | 33.0 | 32.0 | 31.0 | 30.5 | 30.1 | 30.5 |
| Sodium percarbonate | 16.6 | 16.0 | 15.5 | 15.3 | 15.0 | 15.3 |
| TAED | 4.4 | 4.3 | 4.1 | 4.1 | 4.0 | 4.1 |
| Non-ionic Surfactant¹ | 6.6 | 6.4 | 6.2 | 6.1 | 6.0 | 6.1 |
| Polyethylene glycol² | 4.4 | 4.3 | 4.1 | 4.1 | 4.0 | 4.1 |
| PESA (active)³ | — | — | 6.2 | 6.1 | 6.0 | 6.1 |
| Amylase | — | 1.6 | — | 1.5 | 1.5 | — |
| Protease | | 1.6 | — | — | 1.5 | 1.5 |
| Sodium disilicate | 2.0 | 1.8 | 1.9 | 1.8 | 1.8 | 1.8 |

¹DOWFAX ™ 20B102 nonionic surfactant from The Dow Chemical Company
²CARBOWAX ™ 8000 polyethylene glycol from The Dow Chemical Company
³Briteframe PESA (poly epoxy succinic acid, sodium salt) from Sirius International BV

TABLE 2

| | Example (Concentration in wt %) | | | | | | | | | | | | | |
|---|---|---|---|---|---|---|---|---|---|---|---|---|---|---|
| | C5 | C6 | C7 | C8 | C9 | C10 | C11 | 3 | 4 | 5 | 6 | 7 | 8 | 9 |
| Sodium carbonate | 30.5 | 30.5 | 31 | 30.1 | 30.5 | 30.9 | 31 | 30.4 | 32 | 32.3 | 30.1 | 30.7 | 31.5 | 30.1 |
| Sodium citrate | 30.5 | 30.5 | 31 | 30.1 | 30.5 | 30.9 | 31 | 30.4 | 32 | 32.3 | 30.1 | 30.7 | 31.5 | 30.1 |
| Sodium percarbonate | 15.3 | 15.3 | 15.5 | 15 | 15.3 | 15.5 | 15.5 | 15.2 | 16 | 16.1 | 15 | 15.4 | 15.7 | 15 |
| TAED | 4.1 | 4.1 | 4.1 | 4 | 4.1 | 4.1 | 4.1 | 4 | 4.3 | 4.3 | 4 | 4.1 | 4.2 | 4 |
| Non-ionic Surfactant¹ | — | 6.1 | 6.2 | 6 | 6.1 | 6.2 | 6.2 | 6.1 | 6.4 | 6.4 | 6 | 6.2 | 6.3 | 6 |
| Polyethylene glycol² | 4.1 | 4.1 | 4.1 | 4 | 4.1 | 4.1 | 4.1 | 4 | 4.3 | 4.3 | 4 | 4.1 | 4.2 | 4 |
| PESA (active)³ | 6.1 | — | — | — | — | 6.2 | 6.2 | 6.1 | 1.6 | 0.8 | 6 | 6.2 | 3.1 | 6 |
| Amylase | — | 4.5 | — | 1.5 | — | — | — | — | — | — | — | — | — | — |
| Protease | 1.5 | — | — | 1.5 | 1.5 | 0.3 | 0.1 | 1.5 | 1.6 | 1.6 | 3 | 0.8 | 1.6 | 1.5 |
| Sodium disilicate | 1.8 | 1.8 | 1.9 | 1.8 | 1.8 | 1.8 | 1.8 | 1.8 | 1.8 | 1.9 | 1.8 | 1.8 | 1.9 | 1.8 |
| Dispersant-1⁴ | — | — | — | — | — | — | — | — | — | — | — | — | — | — |
| Dispersant-2⁵ | — | 6.1 | 6.2 | 6 | 6.1 | — | — | — | — | — | — | — | — | — |
| Bismuth | — | — | — | — | — | — | — | 0.5 | — | — | — | — | — | — |
| Citrate | | | | | | | | | | | | | | |
| NaLAS⁶ | 6.1 | — | — | — | — | — | — | — | — | — | — | — | — | 1.5 |

¹DOWFAX ™ 20B102 nonionic surfactant from The Dow Chemical Company
²CARBOWAX ™ 8000 polyethylene glycol from The Dow Chemical Company
³Briteframe PESA (poly epoxy succinic acid, sodium salt) from Sirius International BV
⁴ACUSOL ™ 445NG dispersant polymer from The Dow Chemical Company
⁵ACUSOL ™ 527G dispersant polymer from The Dow Chemical Company
⁶Disponil LDBS 55 from BASF

TABLE 3

| | Example (Concentration in wt %) | | | | |
|---|---|---|---|---|---|
| Ingredient | C12 | C13 | C14 | C15 | C16 |
| Sodium carbonate | 30.1 | 31 | 30.5 | 30.5 | 32 |
| Sodium citrate | 30.1 | 31 | 30.5 | 30.5 | 32 |
| Sodium percarbonate | 15 | 15.5 | 15.3 | 15.3 | 16 |
| TAED | 4 | 4.1 | 4.1 | 4.1 | 4.3 |
| Non-ionic surfactant¹ | 6 | 6.2 | 6.1 | 6.1 | 6.4 |
| Polyethylene glycol² | 4 | 4.1 | 4.1 | 4.1 | 4.3 |
| PESA (active)³ | 0 | 0 | 0 | 0 | 0 |
| Amylase | 1.5 | 0 | 0 | 1.5 | 1.6 |
| Protease | 1.5 | 0 | 1.5 | 0 | 1.6 |
| Sodium disilicate | 1.8 | 1.9 | 1.8 | 1.8 | 1.8 |
| Dispersant-1⁴ | 6 | 6.2 | 6.1 | 6.1 | 0 |
| Dispersant-2⁵ | 0 | 0 | 0 | 0 | 0 |

¹DOWFAX ™ 20B102 nonionic surfactant from The Dow Chemical Company
²CARBOWAX ™ 8000 polyethylene glycol from The Dow Chemical Company
³Briteframe PESA (poly epoxy succinic acid, sodium salt) from Sirius International BV
⁴ACUSOL ™ 445NG dispersant polymer from The Dow Chemical Company
⁵ACUSOL ™ 527G dispersant polymer from The Dow Chemical Company

### Procedure for Preparing Food Soil

The STIWA food soil described in TABLE 4 was prepared by the following procedure.
a) Bringing the water to a boil.
b) Mixing in a plastic cup the instant gravy, the benzoic acid and the starch; and then adding the mixture to the boiling water.
c) Adding the milk and margarine to the product of (b).
d) Letting the product of (c) cool down to approximately 40° C.
e) Combining in another plastic cup, the egg yolk, the ketchup and the mustard and mixing with a spoon.
f) Mixing the product of (e) with the mixture of (d).
   Placing 50 g of the product of (f) into 100 mL glass pots and then deep freezing until used.

TABLE 4

| Ingredient | g |
|---|---|
| Water | 700 |
| Margarine | 100 |
| Gravy Powder | 25 |
| Potato Starch | 5 |
| Benzoic Acid | 1 |
| Egg Yolk | 3 |
| Mustard | 25 |
| Ketchup | 25 |
| Milk | 50 |

### Dishwashing Test Conditions

Machine: Miele SS-ADW, Model G1222SC Labor. Wash at 65° C.-30 min/rinse 65° C. Water: 600 ppm total hardness, Ca⁺²:Mg⁺²=3:1. Ratio of Deionized water with 300 ppm Na-bicarbonate (TH=37° F.H, TAC=23° F.H). Food soil: 50 g of the composition noted in TABLE 4 was introduced to the wash liquor frozen in a cup. Each dishwashing composition from Comparative Examples C1-C17 and Examples 1-8 were dosed at 18 g per wash.

### 5 Cycle Filming and Spotting Evaluation

After each of 5 wash cycles under the above dishwashing test conditions, the glass tumblers, wine glasses, styrene-acrylonitrile (SAN) plastic tumblers and stainless steel butter dishes were dried in open air. After drying, filming and spotting ratings were determined by trained evaluators by observations of glass tumblers, wine glasses, SAN tumblers in a light box with controlled illumination from below; and by observations of the stainless steel butter dishes with controlled illumination from above. Glass tumblers, wine glasses, SAN tumblers and stainless steel butter dishes were rated for filming (F) and spotting (S) according to ASTM method ranging from 1 (no film/spots) to 5 (heavily filmed/spotted). An average value of 1 to 5 for filming and spotting was determined as reported in TABLE 5. Also reported in TABLE 5 are the values for overall spot, overall film and overall shine (i.e., overall spot+overall film) for each dishwashing composition. The increase in the weight of the dishwasher drain filter following the 5 wash cycles is also reported in Table 5.

TABLE 5

| | Tumblers | | Wine | | SAN | | Butter | | Overall | | | Filter |
|---|---|---|---|---|---|---|---|---|---|---|---|---|
| Comp. | F | S | F | S | F | S | F | S | F | S | Shine | Res. (g) |
| C1 | 2 | 5 | 1 | 5 | 1 | 5 | 1 | 5 | 5 | 20 | 25 | 1.55 |
| C2 | 2 | 4.75 | 3 | 4.75 | 3 | 4 | 2 | 4.75 | 10 | 18.25 | 28.25 | 1.27 |
| C3 | 3 | 2.5 | 2 | 3.5 | 3 | 2.5 | 2.5 | 3 | 10.5 | 11.5 | 22 | 0.52 |
| C4 | 3 | 2.5 | 2 | 3.5 | 1 | 2.5 | 3 | 3 | 9 | 11.5 | 20.5 | 0.22 |
| C5 | 4.5 | 3.5 | 4.5 | 5 | 2 | 3.5 | 1.5 | 3 | 12.5 | 15 | 27.5 | 1.11 |
| C6 | 1 | 5 | 3.5 | 5 | 1 | 5 | 4 | 5 | 9.5 | 20 | 29.5 | 0.64 |
| C7 | 1 | 5 | 3.5 | 5 | 1 | 5 | 4 | 5 | 9.5 | 20 | 29.5 | 0.83 |
| C8 | 2.5 | 2 | 3 | 4.5 | 4.5 | 2.5 | 2 | 2 | 12 | 11 | 23 | 1.38 |
| C9 | 2.5 | 4.5 | 3 | 5 | 2 | 3 | 2 | 4 | 9.5 | 16.5 | 26 | 1.08 |
| C10 | 5 | 2 | 4 | 4.5 | 3 | 2 | 3.5 | 2.5 | 15.5 | 11 | 26.5 | 0.05 |
| C11 | 3 | 2 | 3.5 | 5 | 3 | 2 | 3.5 | 3.5 | 13 | 12.5 | 25.5 | 0.08 |
| C12 | 1.5 | 2 | 3 | 4.5 | 1.5 | 2 | 3 | 3.5 | 9 | 12 | 21 | 0.98 |
| C13 | 2 | 3 | 3 | 4.5 | 1.5 | 3 | 3.5 | 4.5 | 10 | 15 | 25 | 1.13 |
| C14 | 1.5 | 2 | 4 | 3.5 | 1.5 | 2 | 2 | 3.5 | 9 | 11 | 20 | 1.04 |
| C15 | 2.5 | 3 | 3 | 4.5 | 1.5 | 3 | 2 | 3.5 | 9 | 14 | 23 | 0.94 |
| C16 | 3 | 5 | 3 | 5 | 2 | 5 | 3 | 5 | 11 | 20 | 31 | 1.36 |
| 1 | 1 | 1.5 | 5 | 3 | 2 | 1.5 | 1.5 | 2.5 | 9.5 | 8.5 | 18 | 0.16 |
| 2 | 1 | 1.5 | 5 | 3 | 2 | 1 | 1.5 | 2.5 | 9.5 | 8 | 17.5 | 0.04 |
| 3 | 2 | 2.5 | 5 | 3 | 1.5 | 2 | 1 | 2 | 9.5 | 9.5 | 19 | 0 |
| 4 | 1.5 | 3.5 | 2 | 5 | 1.5 | 3 | 1 | 2 | 6 | 13.5 | 19.5 | 1.18 |
| 5 | 1.5 | 3 | 2 | 5 | 1.5 | 3 | 1 | 2.5 | 6 | 13.5 | 19.5 | 1.07 |
| 6 | 2.5 | 2 | 5 | 2 | 1 | 2 | 1.5 | 2 | 10 | 8 | 18 | 0.23 |
| 7 | 3 | 1 | 5 | 2.5 | 1 | 2 | 2 | 2 | 11 | 7.5 | 18.5 | 0.1 |
| 8 | 1.5 | 2.5 | 2 | 5 | 1.5 | 2 | 5 | 1.5 | 10 | 11 | 21 | 0.75 |
| 9 | 2.5 | 2 | 3.5 | 4.5 | 2 | 1.5 | 2 | 3 | 10 | 11 | 21 | 0.07 |

### 15 Cycle Filming and Spotting Evaluation

After each of 15 wash cycles under the above dishwashing test conditions, the glass tumblers, wine glasses, styrene-acrylonitrile (SAN) plastic tumblers and stainless steel butter dishes were dried in open air. After drying, filming and spotting ratings were determined by trained evaluators by observations of glass tumblers, wine glasses, SAN tumblers in a light box with controlled illumination from below; and by observations of the stainless steel butter dishes with controlled illumination from above. Glass tumblers, wine glasses, SAN tumblers and stainless steel butter dishes were rated for filming (F) and spotting (S) according to ASTM method ranging from 1 (no film/spots) to 5 (heavily filmed/spotted). An average value of 1 to 5 for filming and Spotting was determined as reported in TABLE 6. Also reported in TABLE 6 are the values for overall spot, overall film and overall shine (i.e., overall spot+overall film) for each dishwashing composition. The increase in the weight of the dishwasher drain filter following the 15 wash cycles is also reported in Table 6.

TABLE 6

| | Tumblers | | Wine | | SAN | | Butter | | Overall | | | Filter |
|---|---|---|---|---|---|---|---|---|---|---|---|---|
| Comp. | F | S | F | S | F | S | F | S | F | S | Shine | Res. (g) |
| C12 | 1.5 | 3.5 | 1.5 | 4 | 1 | 4 | 1.5 | 4.5 | 5.5 | 16 | 21.5 | 5.05 |
| C17^{a} | 1 | 2.5 | 1.5 | 4 | 1 | 3 | 2 | 3 | 5.5 | 12.5 | 18 | 3.89 |
| C18^{b} | 1.5 | 2 | 5 | 2.5 | 1 | 2 | 1.5 | 2 | 9 | 8.5 | 17.5 | 0.19 |
| 1 | 1 | 2 | 2.5 | 4.5 | 1 | 2 | 1.5 | 2 | 6 | 10.5 | 16.5 | 0.84 |

^{a}Commercial Frosch Ecological automatic dishwashing formulation from Werner & Mertz GmbH
^{b}Commercial Finish Powerball Quantum Ultimate dishwashing formulation from Reckitt Benckiser plc

We claim:

1. An automatic dishwashing composition, comprising:
20 to <98.6 wt %, based on weight of the automatic dishwashing composition, of a builder;
0.2 to 20 wt %, based on weight of the automatic dishwashing composition, of a nonionic surfactant;
0.1 to <10 wt %, based on weight of the automatic dishwashing composition, of a substance of formula I 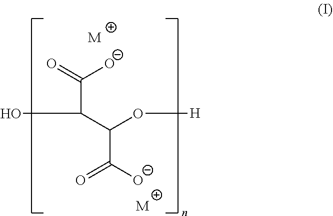
wherein n is ≥2 and wherein each M^{⊕} is a counter ion;
>0.005 to 6 wt %, based on weight of the automatic dishwashing composition, of a protease; and
wherein the weight of the substance of formula I divided by the weight of the protease in the automatic dishwashing composition is <20.

2. The automatic dishwashing composition of claim 1, wherein the automatic dishwashing composition contains >0.3 to 6 wt %, based on weight of the automatic dishwashing composition, of a protease.

3. The automatic dishwashing composition of claim 2, wherein the automatic dishwashing composition is an anhydrous formulation containing <2 wt %, based on weight of the automatic dishwashing composition, of water.

4. The automatic dishwashing composition of claim 3, wherein the automatic dishwashing composition contains <2 wt %, based on weight of the automatic dishwashing composition, of alkyl benzene sulfonates.

5. The automatic dishwashing composition of claim 4, wherein the automatic dishwashing composition contains less than 0.1 wt %, based on weight of the automatic dishwashing composition, of an iron and manganese chelating agent selected from the group consisting of:
a) amino carboxylates having one or more units of the substructure: 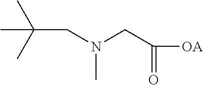
b) amino phosphonates having one or more units of the substructure: 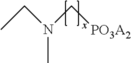
c) polyfunctionally-substituted aromatic chelating agents consisting of compounds having the formula: 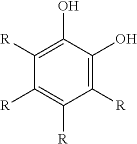
wherein A is hydrogen, an alkali metal, ammonium or substituted ammonium;
wherein x is 1 to 3; and wherein at least one R is —SO₃H, or —COOH or soluble salts thereof and mixtures thereof;
d) mixtures thereof.

6. The automatic dishwashing composition of claim 5, wherein the builder is selected from the group consisting of carbonate, bicarbonate, citrate, silicate and mixtures thereof.

7. The automatic dishwashing composition of claim 6, wherein the automatic dishwashing composition is phosphate free and phosphonate free.

8. The automatic dishwashing composition of claim 7, further comprising an additive selected from the group consisting of a bleaching agent, a bleach activator, an enzyme, a filler, and mixtures thereof.

9. The automatic dishwashing composition of claim 8, further comprising an additive, wherein the additive includes a mixture of a bleaching agent; a bleach activator and an amylase.

10. A method of cleaning an article in an automatic dishwashing machine, comprising:
providing at least one soiled article;
providing an automatic dishwashing composition according to claim 1; and,
applying the automatic dishwashing composition to the at least one soiled article to provide a cleaned article.
